(19) United States
(12) Patent Application Publication
(10) Pub. No.: US 2010/0121969 A1
(43) Pub. Date: May 13, 2010

(54) Broadcasting over the internet

(76) Inventor: Gutman Levitan, Stamford, CT (US)

Correspondence Address: Gutman Levitan, 122 EGRET DRIVE, JUPITER, FL, 33458, US

(21) Appl. No.: 12/291,522

(22) Filed: Nov. 12, 2008

(51) Int. Cl. G06F 15/16

(52) U.S. Cl. 709/231

(57) ABSTRACT

A method and system for reducing Internet congestion and latency by transmitting popular content in a broadcast manner. First a single copy of content is delivered from its origin server located anywhere in the world to a broadcast server according to the standard Internet protocol. From the server, that serves a system of interconnected networks in a regional domain, the content is transmitted as a flow of packets with a flow number placed in the packet's datagram header. The number is provided to client computers as an alias of URL, which is the content identifier on the Internet. Clients that have requested the same content by URL simultaneously download the flow of packets with the flow number in the packet header thereby avoiding congestion and as a result, delays in content delivery created by transmission of multiple copies of the same content at clients' different Internet addresses.

### FIELD OF THE INVENTION

This invention relates to the field of computer networks and more specifically, to technology for reducing Internet congestion and latency.

### BACKGROUND OF THE INVENTION

Internet congestion is originated in the Internet protocol, known as TCP/IP, that delivers data at network addresses thus serving a separate copy of Internet content to each client computer even when many clients are requesting the same content. The one-to-one delivery model provides interactivity and an obvious way of error handling but it wastes bandwidth whenever a high-demand content is transmitted. Bandwidth determines the network throughput and is the most limited network resource. When there is not enough bandwidth, traffic congestion causes delays in content delivery. Today the more users are trying to access the same web content, the more chance they experience delays in content presentation. The growing demand of bandwidth-hungry video over the Internet is putting a strain on Internet service providers (ISPs) who are fighting back by limiting access and/or interfering in Internet traffic.

This problem is not known in radio and television because in a broadcast system multiple receivers are tuned to the same channel, receive the same signal and thus get the same “copy” of content. In digital radio and television, audio and video is transmitted as a stream of packets and a channel identifier is included in the packet header. Bandwidth is reserved for each channel and user's choice is limited to what is scheduled for transmission on the channels. Like dedicated phone lines, which waste bandwidth when not used, dedicated channels waste bandwidth when a content in low or no demand is transmitted.

IP multicasting is a technique for conserving bandwidth by sending packets from one Internet location to many others without unnecessary packet duplication. According to this technique, one packet stream, which could be audio or video or data, is sent from a source to many locations on the Internet and is replicated in the network as needed to reach simultaneously as many end-users as necessary. Multicast commercial applications include webcasting, multiparty computer games and conference calls.

User take advantage of multicasting via multicast applications that run multicast protocols: IGMP that connects a user computer to a multicast group and PIM that sets up a multicast distribution tree for the group. This indirect access limits user's choice of content to what is delivered by available multicast applications. Meanwhile users are accustomed to access Internet content directly with the content identifier URL (Uniform Resource Locator) by typing or copying URL in the browser address bar or just clicking on links.

Another multicast problem is handling transmission errors. The guaranteed error-free data delivery over the Internet is provided by an acknowledgement mechanism of TCP protocol. According to the protocol, the sender retransmits a packet if the receiver does not acknowledge the reception of the error-free packet. The positive acknowledgement or ACK provides for both packets recovery and congestion control—the sender slows down if ACKs are delayed. A “negative acknowledgement” or NAK, which is a request for retransmission of a lost or corrupted packet, is used for packet recovery only. In a multicast application, many client computers receive the same packet stream and therefore the same corrupted packet, which is a problem if a guaranteed error-free data delivery is required. On one hand, if each client submits a retransmission request it would essentially reduce the multicast bandwidth savings. On the other hand, it would be wrong to designate a particular client computer in a multicast group as a retransmission requester on behalf of all clients because the group formation is out of control: any client can join or leave the group at any time. In audio and video, errors can be localized but computer programs with transmission errors do not work. That is why IP multicasting, which incorporates UDP instead of TCP in the network layer, is mainly used for transmission of audio/video streams and does not fit for distribution of software, such as security patches or media players.

More practical method of bandwidth saving is web caching. Many ISPs, universities and corporations are using proxy caches to store copies of frequently accessed web content so that subsequent requests may be satisfied from the cache if certain conditions are met. Web caching provides essential bandwidth savings because a single copy of content is delivered from its origin server located anywhere in the world to a proxy cache positioned closer to users. But the savings are partial rather than complete because from the proxy server the content is distributed to client computers in separate copies.

U.S. Pat. No. 7,240,105 to Satran et al. discloses a method and system that combines content caching with multicast data delivery. The cache is formed as a multilevel hierarchical tree so that requests for content by end-user clients are received by the lowest level cache and forwarded as necessary to higher levels in the hierarchy.

U.S. Pat. No. 7,133,928 to McCanne discusses advantages of an application-level overlay routing protocol. Exploiting multicasting in a singly administered regional domain, as opposite to disjoint multicast networks that span multiple administrative domains with heterogeneous equipment and different multicast implementations, the protocol allows data distribution and bandwidth management to be handled in a more cohesive and intelligent fashion.

U.S. Pat. No. 6,374,303 to Armitage et al. discloses a multicast adaptation of Internet MPLS protocol. MPLS, which stands for Multi-Protocol Label Switching, provides for explicit routing and as a result, more efficient data forwarding based on the use of fixed size labels attached to packets.

U.S. Pat. No. 6,061,738 to Osaku et al. teaches using numbers as URL aliases and thereby avoiding the need to know and input URLs, which are long strings of characters.

U.S. Pat. No. 6,973,050 to Birdwell et al. discloses a transmission announcement system for use in conjunction with a unidirectional data broadcast system in which data is served simultaneously to multiple clients. The system sends out announcements of upcoming broadcast transmissions thereby enabling clients to select and receive transmissions of interest. The announcements contain such information as URL, broadcast protocol, transmission time and channel, and subject matter and rating of transmitted content.

U.S. Pat. Nos. 6,698,023, 6,965,913, 7,092,999 and 7,356,751 to the applicant disclose a system that delivers high-demand Internet content over a combined Internet/television infrastructure. The delivery is performed in two steps. First, a single copy of content is delivered according to the standard Internet protocol from its origin web server located anywhere in the world to a server at a television station. From the station, the content is transmitted in a broadcast manner so that all client computers in the station's servicing area could download it simultaneously. Each client computer automatically downloads content of user's choice at the time of transmission and stores it on its hard drive thereby making the content instantly available to the user at the time of user's choice. Without any change to the existing Internet infrastructure and protocol, the system reduces Internet congestion and provides virtually instant access to content of common interest. The technology however spans two industries with different cultures and policies. Television companies may resist the convergence for a number of reasons, in particular because video delivery over the Internet may eventually supplant the conventional television. It is therefore desirable to find a way for broadcasting over the Internet alone.

### SUMMARY

Accordingly, reducing Internet congestion and latency by transmitting popular content in a broadcast manner is the main object of the present invention.

Another object is to provide virtually instant access to web content of common interest.

A further object is to facilitate distribution of full-length DVD-quality video over the Internet without putting a strain on Internet service providers.

A still further object is to facilitate a guaranteed error-free delivery of software simultaneously to unlimited number of Internet client devices.

In keeping with this object and with others, which will become apparent hereinafter, the present invention consists, briefly stated, in two-step delivery as follows. First a single copy of content is delivered from its origin server located anywhere in the world to a broadcast server according to the standard Internet protocol. From the server, which serves a system of interconnected networks in a regional domain, the content is transmitted as a flow of packets with a flow number placed in the packet's datagram header. The number is provided to client computers as an alias of URL, which is the content identifier on the Internet. Clients that have requested the same content by URL simultaneously download the same flow of packets with the flow number in the packet header thereby avoiding congestion and as a result, delays in content delivery created by transmission of multiple copies of the same content at clients' different Internet addresses.

The novel features, which are considered as characteristic for the present invention, are set forth in particular in the appended claims. The invention itself, however, will be best understood from the following description of specific embodiment when read in connection with the accompanying drawings.

### BRIEF DESCRIPTION OF THE DRAWINGS

FIG. 1 illustrates a broadcasting system according to the present invention.

FIG. 2 illustrates the layered Internet protocol.

FIG. 3a shows the layout of IP datagram header.

FIG. 3b shows a layout of datagram header modified for flow routing.

FIG. 4 shows the layout of Ethernet frame.

FIG. 5 shows the layout of entry in a flow-forwarding table.

FIG. 6 shows statistics of retransmission requests for packets recovery.

### DESCRIPTION OF THE PREFERRED EMBODIMENTS

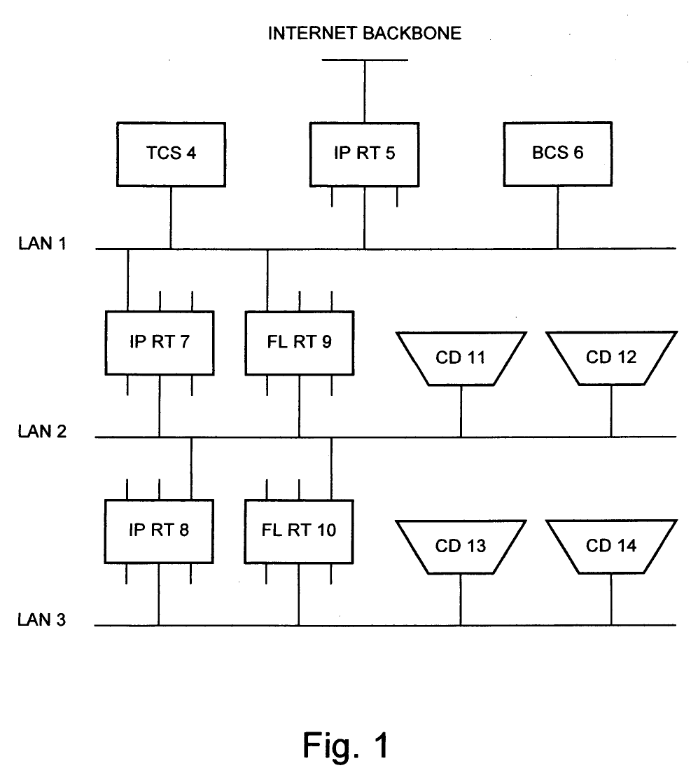

The Internet comprises many regional systems connected by backbones and individually managed by large independent service providers. An autonomous regional system is both a management domain and routing domain: it may use interior routing protocols and maintain interior routing tables. A system for broadcasting over the Internet according to the present invention is illustrated by FIG. 1 that shows only three interconnected local area networks (LANs) 1-3 and a few client devices 11-14 in a singly administered domain while there could be hundreds of LANs and thousands of clients. Users of client devices, such as desktop or laptop computers, personal digital assistants and smart phones, submit requests for Internet content by typing or copying URL, which is the content identifier on the Internet, in the browser address bar or clicking on links. The requests are directed to a traffic control server 4 over “standard” IP routers 7 and 8. A single-client request is served in a usual way i.e., the requested content is delivered from its origin web server directly to the client device at the device network address. If content is requested by more than one client, it is delivered in two steps as follows.

The traffic control server 4 maintains a list of Internet objects, such as web pages or video files, requested by more than one client and instructs a broadcast server 6 to download a single copy of each object of the list no mater how many clients have requested the object. The object is delivered from its origin web server located anywhere in the world over an Internet backbone and IP router 5 to the broadcast server 6. The delivery is performed at the server Internet address according to the standard Internet protocol known as TCP/IP. At the server 6 the object is repackaged for transmission across networks 1-3 as a flow of packets with a flow number placed in the packet's datagram header. Flow routers 9 and 10, which will be described hereafter, forward the packets to the networks. The flow number is provided to client devices as an alias of URL. Clients, that have requested the object by its URL, download the same flow of packets with the flow number in the packet header thereby preventing congestion and as a result, delays in content delivery that may be caused by transmission of multiple copies of the same object at clients' different Internet addresses.

The traffic control server informs client devices about the flow number used as the alias of URL by one of two ways depending on how many clients have ordered the same content and whether the content is open or protected. If there are few requesters or a conditional access needs to be implemented, the server sends an individual notification to each client device at the device Internet address. The notification contains the flow number bound to the URL and in addition, it may contain an encryption key so to enable authorized clients to access a protected content. If there are many requesters and the content is open, the server provides the flow number in a broadcast schedule i.e., a list of Internet objects scheduled for broadcast transmission. The schedule itself is transmitted as a flow of packets with a flow number that is known to client devices in advance.

If during download of a particular content from its origin web server into the broadcast server 6 additional clients request the same content, the traffic control server 4 does not initiate new downloads but notifies all requesters about the incoming broadcast transmission. This allows handling of all requests submitted during the time of delivery via the Internet, which ranges from a fraction of a second to a few seconds, as “simultaneous” and serving them with the same copy of content. In addition, a content in high demand may be retained in the server 6 until it is updated on its origin web server or until high demand for that content is over, thereby further reducing Internet traffic and as a result, Internet congestion and latency.

The major advantage of the Internet is interactivity: user receives content of his choice at the time of his choice. For a popular content the same and even better result may be achieved if the content is broadcasted at least as often as it is changed on its origin web server. Then client devices whose users are interested in that content can download the same copy of content simultaneously and store it on their hard drives thereby making the current version of content instantly available to each user at the time of his choice. This is, in fact, Web caching on the client side. At present, hard disk drive of a client computer can store hundreds of hours of video, millions of still pictures and billions of text and data pages i.e., much more information and entertainment than a user is able to consume. Instead of storing only links to web pages (browser bookmarks), a client device can store news, weather, traffic and other information and automatically update it at the time of scheduled broadcast transmission. Although the high capacity storage is important, Web caching on the client side is unfeasible without data broadcast because delivery of a separate copy of content to each client, whenever the content is updated on its origin web server, would create a huge traffic clogging the Internet.

As to bandwidth-hungry video, it should be understood that live events can be watched live only during their real-time transmission and therefore simultaneously by all viewers. It makes no sense to deliver a separate copy of live event to each user. On the other hand, there is not much urgency to view a “taped” event or show directly from its origin web server. A recorded video can be broadcasted on schedule, e.g. overnight, so that all client devices that ordered the video during the day could download it automatically at the time of transmission—as DVR does. Then each user can watch the video downloaded in his device at the time of his choice. This makes possible distribution of full-length DVD-quality video over the Internet without putting a strain on Internet service providers and as a result, the rise of global demand-driven television as a part of Internet access service.

There are cases when a web site suddenly attracts public attention. For example, NASA web site experiences millions of hits when a probe is landed on Mars. The traffic control server manages such a case as follows. When getting hits from many client devices for a particular content, it instructs the broadcast server to transmit the content permanently each one or two seconds during a certain period of time proportional to the number of clients requested the content. During that time an unlimited number of interested users can receive the content without any noticeable delay while their computers do not send requests to the server. If after the time expiration the server gets hits again, it starts a new cycle of broadcast and so on. If the number of hits goes up, the broadcast cycles get longer and if the number of hits goes down, the cycles get shorter. Eventually when users' interest is over, the server stops the broadcast.

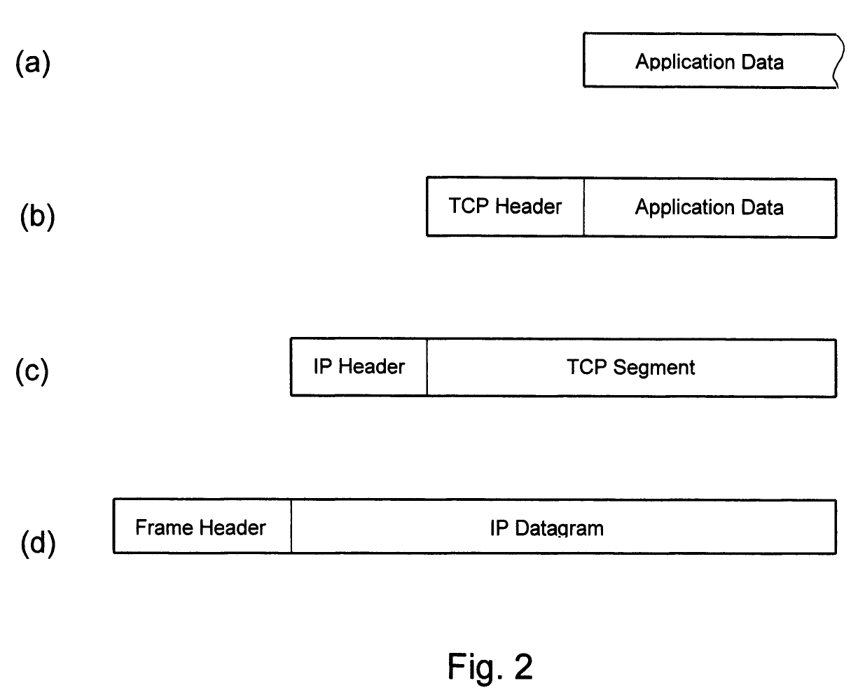

The system of FIG. 1 operates with two routing protocols: the standard IP protocol and a flow routing protocol. Internet protocol, known as TCP/IP, has five layers: application layer, transport layer, network layer, data link layer and physical layer. (The layered system, originated in an international standard known as ISO OSI reference model, was designed to provide interoperability and independence from hardware and software platforms.) On the transmitting side, data is relayed from the highest application layer to the lowest physical layer by adding a header for each layer (FIG. 2). At the receiving side, a packet is processed sequentially from the lowest physical layer to the highest application layer.

A data stream from the application layer (FIG. 2a) is fragmented into parts in the transport layer (FIG. 2b), and the parts are encapsulated into Transmission Control Protocol (TCP) segments. TCP is responsible for data exchange between applications run on different computers. It is a connection-oriented protocol that provides a flow control and a guaranteed error-free data delivery. In the network layer (FIG. 2c), TCP segments are encapsulated into Internet Protocol (IP) datagrams. IP is responsible for end to end packet delivery across multiple router-connected networks. Its primary task is to support internetwork addressing and packet forwarding. In the data link layer (FIG. 2d), IP datagrams are encapsulated into Ethernet frames or ATM cells to be transmitted over a physical medium, i.e. physical layer.

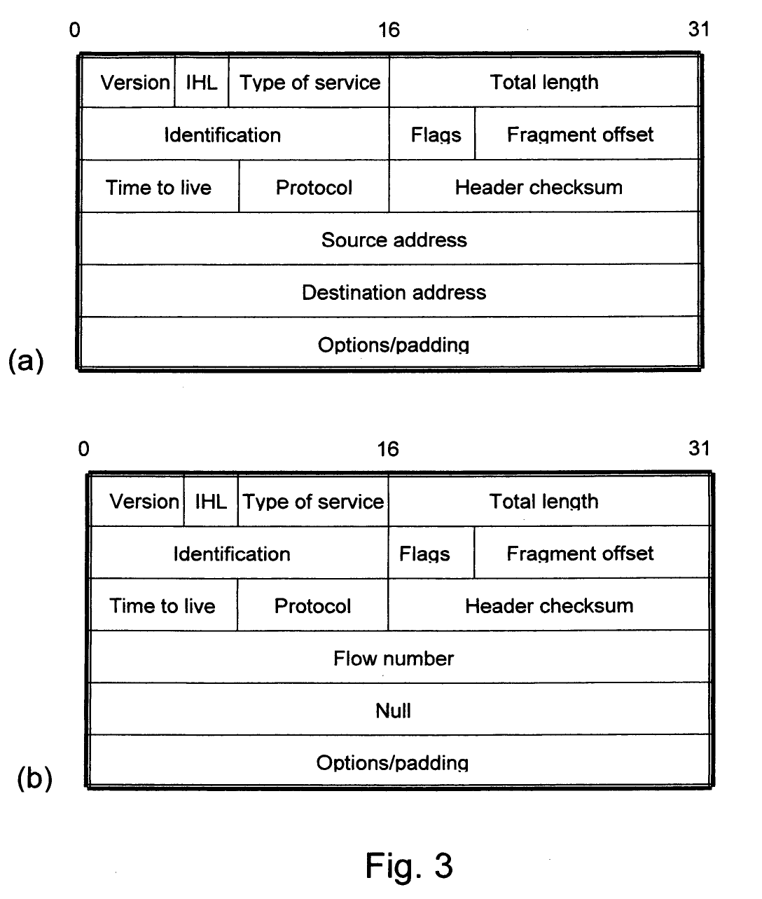

There are two schemes of network addressing: one in the network layer and the other in the data link layer. The network layer address (IP address) is used for end to end packet delivery across multiple router-connected networks. It is a combination of a network address and a node address within the network. The address is a 32-bit binary number divided into four 8-bit fields and contain two pieces of information: the left fields identify a network, i.e. a group of computers, and the right fields identify a host, i.e. a computer on the network. The 32-bit binary values are presented in a dotted-decimal notations like 182.16.3.24 for human convenience. For small number of large networks with many hosts, one 8-bit field is used as the network address and three fields are used as the host address. For large number of small networks with not many hosts, three fields are used as the network address and one field as the host address. IP addresses are placed in source and destination fields of IP datagram header shown in FIG. 3a.

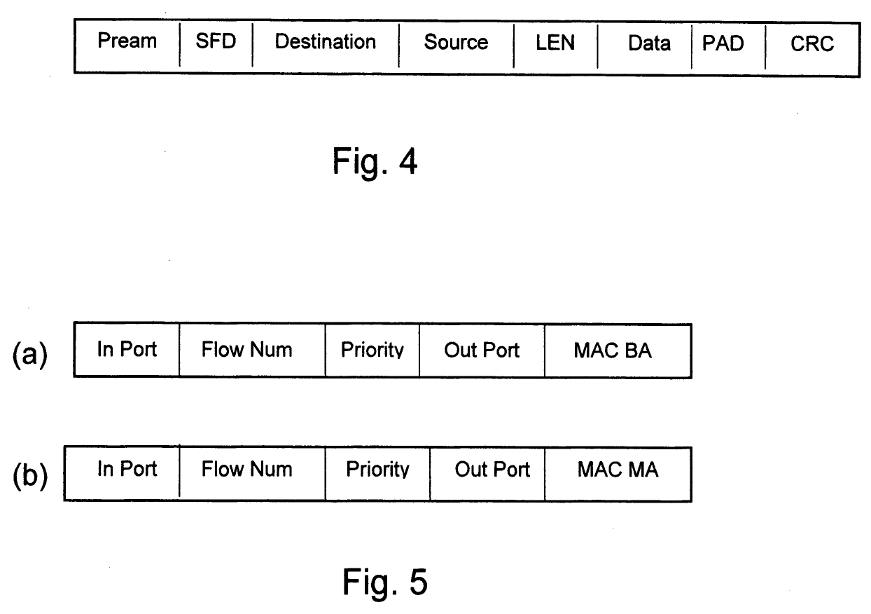

In the data link layer, each network node, which is a server or client or router, has at least one Media Access Control (MAC) address. The address, also called link address, is used for packet delivery inside each LAN. MAC address is hardwired into network interface card (NIC). To make it globally unique, the 48-bit address is divided into two parts: the left 24 bits are assigned to a NIC manufacturer and the right 24 bits are assigned by the manufacturer to a NIC. MAC addresses are placed in the destination and source fields of Ethernet frame shown in FIG. 4.

Both IP and MAC addresses have a value—all binary 1s—for the broadcast address, which is used for sending a message simultaneously to all nodes on the network. Broadcast messages are sent mainly for network management and diagnostic purposes. IP address 255.255.255.255 is the general broadcast address (decimal 255 fills the 8-bit field with all binary 1s). Routers block the address so that nobody could flood the Internet with a message sent to all computers. The broadcast IP address for a specific network has all is in the host portion only. Applications that produce broadcast messages include routing protocols such as RIP. The IP broadcast address however may not be used for broadcasting of a particular web content because not all computers on the network are supposed to receive that content but only those whose users want it.

In addition, there are IP and MAC addresses reserved for multicast. Ethernet NIC accepts packets addressed not only to its hardwired MAC address or to the broadcast address but also packets with a particular “soft” address from the multicast address range.

IP router processes IP datagram header (FIG. 3a). Along with the source and destination addresses the header specifies a protocol version number, a header length, packet fragmentation and reassembly information, maximum number of routers to pass, an error-checking value and other data. (Full information can be found in RFC 791 “Internet Protocol”, September 1981). There are two types of routing over IP networks: hop-by-hop routing to the destination and explicit routing over a predefined pass. In the basic hop-by-hop routing, each router is responsible for determining the next hop, not the complete path. The advantage is that the path may change at any time due to traffic problems or failing links. In the explicit routing, the pass is determined in advance and packets are forwarded without the need to make routing decisions at each router along the pass. The advantages of explicit routing are routing speed and the possibility of traffic engineering, which includes bandwidth management, prevention of routing loops and providing quality of service (QoS) over traffic prioritization.

MPLS (Multiprotocol Label Switching) is the most important Internet protocol of explicit routing that builds virtual circuits across IP networks. MPLS network comprises label-forwarding routers that switch packets and edge devices that determine routes and add labels. When a packet arrives at an ingress edge device, the device looks at the packet IP destination address, determines a pass and attaches a label that will lead the packet over the routers along the pass. The packet then is forwarded by routers, which do not examine IP header but look up their label-forwarding tables. When the packet reaches the egress edge device, the label is removed and the packet is forwarded further on its way via standard IP routing.

Flow routing according to the present invention is also a kind of explicit routing that uses a modified datagram header shown in FIG. 3b to forward packets across the networks along a predetermined pass. For all other purposes, such as packet fragmentation and reassembly, the header is the same as the IP header shown in FIG. 3a but the destination address field is nullified by all binary 0s and the source address is replaced by flow number.

Unlike IP addresses, flow numbers are randomly generated and reusable. Whenever a flow number is assigned, it is placed into “in-use” list. After the flow transmission is completed, the number is removed from the list and can be assigned again to other flow. It ensures that all flows concurrently transmitted across a regional domain have randomly chosen but different flow numbers.

The traffic control server selects a path for each flow over a sequence of flow routers using a routing table that is configured either manually or with the help of known in the art routing protocols, such as RIP (Routing Information Protocol), OSPF (Open Shortest Path First) or BGP (Border Gateway Protocol). The protocols are using routing algorithms to gather information about network topology.

Flow routers store flow-forwarding tables. When the traffic control server sets up a virtual circuit, it sends a notification to each flow router along the selected pass with a command to insert table entries for a flow identified by a flow number. After the flow transmission is completed, the server takes down the virtual circuit by sending a notification to each router with a command to delete table entries related to the flow.

When a packet arrives at a flow router, the router strips the input frame information, retrieves the datagram, reads the datagram header shown in FIG. 3b and looks up its flow-forwarding table. If the flow number is not found in the table, the router drops the packet. Thus packets with a particular flow number in the packet datagram header are forwarded only by those routers that have been provided with an entry for the flow number.

FIG. 5 shows a layout of the table entry. In one embodiment (FIG. 5a), the entry says that if a packet with the specified flow number arrives at the specified input port, it is to be encapsulated in a frame with the MAC broadcast address and directed with the specified priority to the specified output port. Thus real-time video stream may have higher priority than a “taped” video. In other embodiment (FIG. 5b), the datagram is to be encapsulated in an output frame with the specified MAC multicast address. The difference between the two embodiments will be explained hereafter.

Router may be a stand-alone dedicated device from a vendor such as Cisco Systems, or a computer with NICs running a network operating system like Novel NetWare, Sun Microsystems's Solaris or Microsoft Windows 2000. A hardware-based router called “layer 3 switch” uses application-specific integrated circuits (ASICs) and network processors to improve routing performance. Flow routers can be implemented as additional software installed on existing IP routers or as separate routers. In other words, any router on the network may be either an IP only router or a flow router or a two-protocol router.

A client device obtain the flow number associated with the requested URL either from an individual notification sent to the client address or from a broadcast schedule. An extension of web browser, which is designed to support Internet broadcasting in the application layer, processes both the individual notifications and broadcast schedules, extracts the flow number and relays the number down to the network layer. During the flow transmission, an extension, which is designed to support Internet broadcasting at the network layer, accepts incoming packets with the flow number in the packet's datagram header and relays the packets up to the transport layer for further processing.

In the data link layer, IP datagram is placed in the data area of Ethernet frame (FIG. 4) and the frame is transmitted inside LAN with either the broadcast address or a multicast address in the frame's destination field. Frames with the MAC broadcast address are accepted by all NICs connecting routers and client devices to the LAN and transferred up to the network layer where datagrams are filtered out by flow number. Thus packets with a particular flow number in the packet datagram header are accepted by only those client devices that have ordered an Internet content by its URL and then have been provided with the flow number as the alias of the URL.

However the processing of all packets in the network layer, which is performed by CPU, may adversely affect the system performance. The performance can be improved by using MAC multicast addresses in the frame's destination field. Ethernet, which is the most broadly used LAN technology, supports both broadcast and multicast addressing but early, so-called Experimental Ethernet supports broadcast but not multicast addressing. According to IPv4 IGMP protocol, addresses in the MAC multicast address range start with 25-bit multicast prefix 01-00-5E in hexadecimal followed by zero bit thus leaving 23 bits to map the multicast network layer address. The 32-bit IP group address is mapped to the MAC multicast address by placing the low-order 23 bits of the IP address into the low-order 23 bits of the MAC address. Different 32-bit IP addresses with the same 23 low-order bits are mapped to the same MAC multicast address and therefore some unintended packets may reach the network layer. But if it happens not often it does not affect the system performance.

In the embodiment of present invention, the 32-bit flow number is mapped to MAC multicast address. The address “collisions” can be avoided by limiting the assigned flow numbers to 2²³−1. That would limit the number of concurrently transmitted broadcasts in a singly managed regional domain to 8,388,607. Although it seems to be enough, the limitation is unnecessary if flow numbers are randomly generated in the full range 1 to 2³²−1. This allows the number of concurrently transmitted broadcasts in excess of four billion while in real-life situations the probability of address collision is very small.

An estimate of the probability may be obtained from Poisson distribution:

$$f ( k ; λ ) = \frac{{e}^{- λ} {λ}^{k}}{k !} ,$$

where k is the number of occurrences of any particular result in a series of independent trials, k! is the factorial of k, e is the base of the natural logarithm (e=2.71828 . . . ) and A is equal Np where N is the number of trials and p is the probability of any particular result. What we want to know is the probability of generating of more than one flow number (k>1) with the same 23 low-order bits when N different flow numbers are randomly generated for N concurrent broadcasts. Because 23 bits provide for 2²³ different combinations, the probability of generating any particular combination p=2⁻²³. According to Poisson distribution the probability is less than 10⁻⁸ for N=1000, less than 10⁻⁶ for N=10,000 and less than 10⁻² for N=1,000,000. Although with the increase of number of concurrent broadcasts the probability is growing, in most of real-life situations it is small enough and therefore multicast address collisions, as rare events, may not essentially downgrade the system performance.

Different applications led to many different methods for generating random numbers. These methods may vary as to how unpredictable or statistically random the numbers are, and how quickly they can be generated. Physical methods, which produce true random numbers outside the computer environment, are based on the theory of entropy. Sources of entropy include nuclear decay and atmospheric conditions. Computational methods produce pseudo-random numbers, i.e. a sequence of numbers with random properties, but eventually the sequence repeats. For statistical simulations, Mersenne Twister MT19937 is a good choice because it is fast, freely available and has a colossal period of 2¹⁹⁹³⁷−1 (in decimal 4.315425×10⁶⁰⁰¹).

The guaranteed error-free data delivery over the Internet is provided by an acknowledgement mechanism of TCP protocol. According to the protocol, the sender retransmits a packet if the receiver does not acknowledge the reception of the error-free packet. The positive acknowledgement or ACK provides for both packets recovery and congestion control: the sender slows down if ACKs are delayed. In other transport layer protocols built on the top of UDP (User Datagram Protocol), a “negative acknowledgement” or NAK, which is a request for retransmission of lost or corrupted packet, is used for packets recovery only.

However in a broadcast system, many client devices receive the same packet stream and therefore the same corrupted packet, which is a problem if a guaranteed error-free data delivery is required. On one hand, if each client submits a retransmission request it would essentially reduce the broadcast bandwidth savings. On the other hand, it would be wrong to designate a particular client as a retransmission requester on behalf of all clients because the “audience” formation for any particular broadcast is out of control: any client device can join or leave the audience.

In the embodiment of present invention, the guaranteed error-free delivery of a single copy of Internet object from its origin web server located anywhere in the world to the broadcast server in a regional domain is provided by TCP or other transport layer Internet protocol. From the broadcast server to multiple client devices in the regional domain the guaranteed error-free delivery is provided by a method disclosed in U.S. Pat. No. 7,356,751 to the applicant. In the patent, a data broadcast system uses a return channel for audience measurement and packets recovery. Whenever a corrupted packet is detected, the multiple receiving devices play a kind of “lottery game” running generators of random numbers and only “winners” submit retransmission requests over the return channel. While in the game each receiver acts on its own, it is advised by the sender on the audience size, i.e. the overall number of receivers. This allows setting the game so to limit the number of retransmission requests and to keep it independent from the audience size. The sender performs the audience measurement by transmitting packets with wrong error-checking values and evaluating receivers' responses. While the efficient error handling improves the network performance, the audience measurement is important for network business as long as transmitted content is funded by advertisers.

In the embodiment of present invention, the error handling and audience measurement functionality is provided by a transport layer protocol built on the top of UDP. The header of UDP segment is extended to incorporate an audience size estimate. Whenever an error is detected, the client device reads the estimate and generates a random number within a range of numbers, which is a function of the estimate. The client submits a retransmission request only if a particular predetermined number is generated.

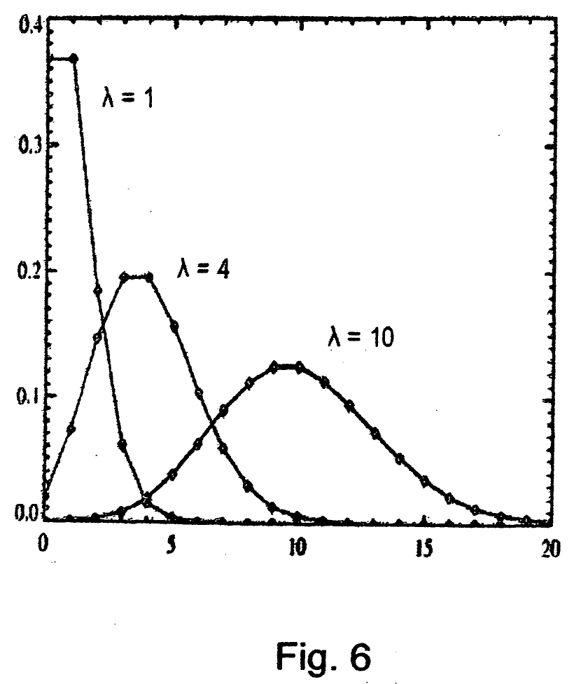

The statistics of expected retransmission requests, which obtained from discussed above Poisson distribution, is illustrated by FIG. 6. The probability of k requests is defined only for integer values of k—the connecting lines are guides for the eye and do not indicate continuity. The parameter λ is the ratio of the audience size to the range of generated numbers and for any audience size the range can be chosen so to confine the number of requests. In the case of λ=1, that is when the range of generated numbers equals the audience size, the average number of requests is 1 and the maximum number is 4. However the probability of k=0 is 0.37, which is unacceptable because at least one client has to submit a retransmission request on behalf of all. Therefore the range of generated random numbers has to be less than the audience size although it increases the number of requests. In the case of λ=4, the average number of requests is 4, the maximum number is 10 and the probability of k=0 is 0.018, which although small, does not exclude the possibility that a retransmission request will not be submitted. In the case of λ=10, the average number of requests is 10, the maximum number is 19 and the probability of k=0 is 0.00005. For the ratio λ=4, the probability of k=0 in two “plays” is 0.0003. This may be recommended for a not real-time transmission when delays in packet delivery are acceptable. For a real-time transmission, the ratio λ=10 is preferable.

Retransmission requests are directed to the traffic control sever in the same way as the original requests for content with the difference that URL, which may be a long string of characters, is replaced by its alias, i.e. the flow number, and a packet sequence number is added. The traffic control server identifies identical retransmission requests and relays only one request per packet to the broadcast server.

In audio and video, transmission errors, although annoying, can be localized but computer programs with errors do not work. Packets recovery may improve video broadcast over the Internet and more important, it facilitates distribution of software, such as security patches or media players, simultaneously to unlimited number of Internet client devices.

Although the invention is described herein with reference to the preferred embodiment, it is to be understood that modifications can be made by those skilled in the art without departing from the spirit or scope of the invention. Accordingly, the invention should only be limited by the claims included below.

What is claimed is:

1. A method of reducing Internet congestion and latency by distributing popular content in a broadcast manner, comprising the steps of:
delivering according to a standard Internet protocol a single copy of a particular content, defined by an Internet identifier, from that content origin server to a broadcast server that serves a plurality of networks in a regional domain;
at the broadcast server, repackaging said content for a broadcast transmission across said plurality of networks;
assigning a flow number to a flow of packets carrying said content and placing the flow number in the packet's datagram header for use as an alias of said Internet identifier;
before the broadcast transmission, informing client devices of said plurality of networks about the flow number used as the alias of Internet identifier so that the client devices would be able to distinguish packets carrying said content from other packets transmitted over the networks; and
setting up a path across said plurality of networks for delivery of the flow of packets to the client devices by providing the flow number to each router along the path;
thereby enabling client devices, which have requested the same content, to simultaneously download the flow of packets carrying that content and thus to avoid congestion and as a result, delays in content delivery created by transmission of multiple copies of the same content at clients' different Internet addresses.

2. The method of claim 1 wherein client devices are informed about the flow number used as the alias of Internet identifier by sending an individual notification to each client device at the device Internet address, said notification containing the flow number bound to the Internet identifier.

3. The method of claim 1 wherein client devices are informed about the flow number used as the alias of Internet identifier by including the flow number bound to the Internet identifier in a list of scheduled for broadcast Internet objects and transmitting the list with a flow number known to the client devices.

4. The method of claim 1 wherein inside each network of said plurality of networks, packets are transmitted in frames with a broadcast address in the frame's destination field so that the packets would be accepted by all client devices at the data link layer and then filtered out by said flow number at the network layer.

5. The method of claim 1 wherein inside each network of said plurality of networks, packets are transmitted in frames with a multicast address in the frame's destination field, said multicast address being produced by mapping the flow number to Ethernet multicast address.

6. The method of claim 1 further comprising the step of retaining content in high demand at the broadcast server until the demand is over or content changes at its origin server so to further reduce Internet traffic and delays in content delivery.

7. A system adapted to perform the method of claim 1.

8. A system adapted to perform the method of claim 2.

9. A system adapted to perform the method of claim 3.

10. A system adapted to perform the method of claim 4.

11. A system adapted to perform the method of claim 5.

12. A system adapted to perform the method of claim 6.
